(19) United States
(12) Patent Application Publication
(10) Pub. No.: US 2012/0099600 A1
(43) Pub. Date: Apr. 26, 2012

(54) TRANSCEIVER HAVING HEAC AND ETHERNET CONNECTIONS

(75) Inventor: TIEN-JU TSAI, TAINAN COUNTY (TW)

(73) Assignee: HIMAX MEDIA SOLUTIONS, INC., TAINAN COUNTY (TW)

(21) Appl. No.: 12/908,772

(22) Filed: Oct. 20, 2010

(51) Int. Cl. H04L 12/56

(52) U.S. Cl. 370/401

(57) ABSTRACT

A transceiver having HEAC and Ethernet connections is disclosed. An active hybrid & common-mode bias (AHCB) unit facilitates the transmission of differential transmission signals and the reception of first differential reception signals. An Ethernet line gate controllably configures the pairing among first and second differential Ethernet signals, the differential transmission signals and second differential reception signals. An Ethernet physical-layer (PHY) transceiving unit receives both or one of the first and second differential reception signals and the differential transmission signals, followed by processing the reception signals at a physical layer.

### BACKGROUND OF THE INVENTION

1. Field of the Invention

The present invention generally relates to Ethernet networking, and more particularly to a transceiver having an HDMI Ethernet & Audio Return Channel (HEAC) connection and a wired Ethernet connection.

2. Description of Related Art

Ethernet is a computer networking technique that is widely used in constructing a local area network. Fast Ethernet or 100BASE-TX, for example, is specified in IEEE 802.3 and can transfer data at a nominal rate of 100 Mbits/sec. An Ethernet transceiver primarily includes a physical-layer (PHY) transceiving port, a Media Access Control (MAC) interfacing port and some upper-layer protocol processors.

High-Definition Multimedia Interface (HDMI) is a compact audio/video interface for transmitting uncompressed digital data. HDMI version 1.4 provides, among others, an HDMI Ethernet Channel (HEC), which allows for a 100 Mbit/sec Ethernet connection between two HDMI connected devices. HDMI 1.4 also provides an Audio Return Channel (ARC) that enables a HDMI device to send audio data or bitstream to an HDMI connected device.

In order to support HDMI 1.4 (or later version) in the conventional Ethernet transceiver, a second PHY transceiving port and a second MAC interfacing port need to be constructed. However, two pairs of PHY transceiving ports and MAC interfacing ports disadvantageously increase chip area and consumed power. Moreover, most devices such as network terminals actually do not use the HDMI Ethernet & Audio Return Channel (HEAC) and the conventional wired Ethernet at the same time.

For the foregoing reason, a need has arisen to propose a novel transceiver having the HEAC connection and the wired Ethernet connection.

### SUMMARY OF THE INVENTION

In view of the foregoing, it is an object of the embodiments of the present invention to provide a transceiver that can support both the HDMI Ethernet & Audio Return Channel (HEAC) connection and the conventional wired Ethernet connection in a cost-effective manner. Further, the embodiments of the present invention can intelligently switch the incoming HDMI and Ethernet signals to obtain an optimized performance.

According to a first embodiment, the transceiver includes a pair of HDMI input/output (I/O) nodes, an active hybrid & common-mode bias (AHCB) unit, a pair of first Ethernet I/O nodes, a pair of second Ethernet I/O nodes, an Ethernet line gate, a pair of first multiplexers and an Ethernet physical-layer (PHY) transceiving unit. The AHCB unit facilitates the transmission of a pair of differential transmission signals, and reception of a pair of first differential reception signals. The Ethernet line gate controllably connects the first differential Ethernet signals with one pair of the differential transmission signals and a pair of second differential reception signals, and controllably connects the second differential Ethernet signals with the other pair of the differential transmission signals and the second differential reception signals. The first multiplexers select either the first differential reception signals or the second differential reception signals. The Ethernet PHY transceiving unit receives and processes the selected first or second differential reception signals and the differential transmission signals at a physical layer.

According to a second embodiment, the first multiplexers are omitted. Instead, the Ethernet PHY transceiving unit receives both the first and second differential reception signals, and then processes one of the first and second differential reception signals and the differential transmission signals at a physical layer.

### BRIEF DESCRIPTION OF THE DRAWINGS

FIG. 1 shows a block diagram of a transceiver having an HDMI Ethernet & Audio Return Channel (HEAC) connection and a wired Ethernet connection according to a first embodiment of the present invention;

FIG. 2 shows a detailed circuit of an exemplary implementation of the active hybrid & common-mode bias unit of FIG. 1;

FIG. 3A shows a schematic diagram of the Ethernet line gate of FIG. 1;

FIG. 3B shows a detailed circuit of an exemplary implementation of the Ethernet line gate of FIG. 1;

FIG. 4 shows a detailed block diagram of the Fast Ethernet PHY transceiving unit of FIG. 1 according to the first embodiment of the present invention;

FIG. 5 shows a block diagram of a transceiver having an HEAC connection and a wired Ethernet connection according to a second embodiment of the present invention; and

FIG. 6 shows a detailed block diagram of the Fast Ethernet PHY transceiving unit of FIG. 5 according to the second embodiment of the present invention.

### DETAILED DESCRIPTION OF THE INVENTION

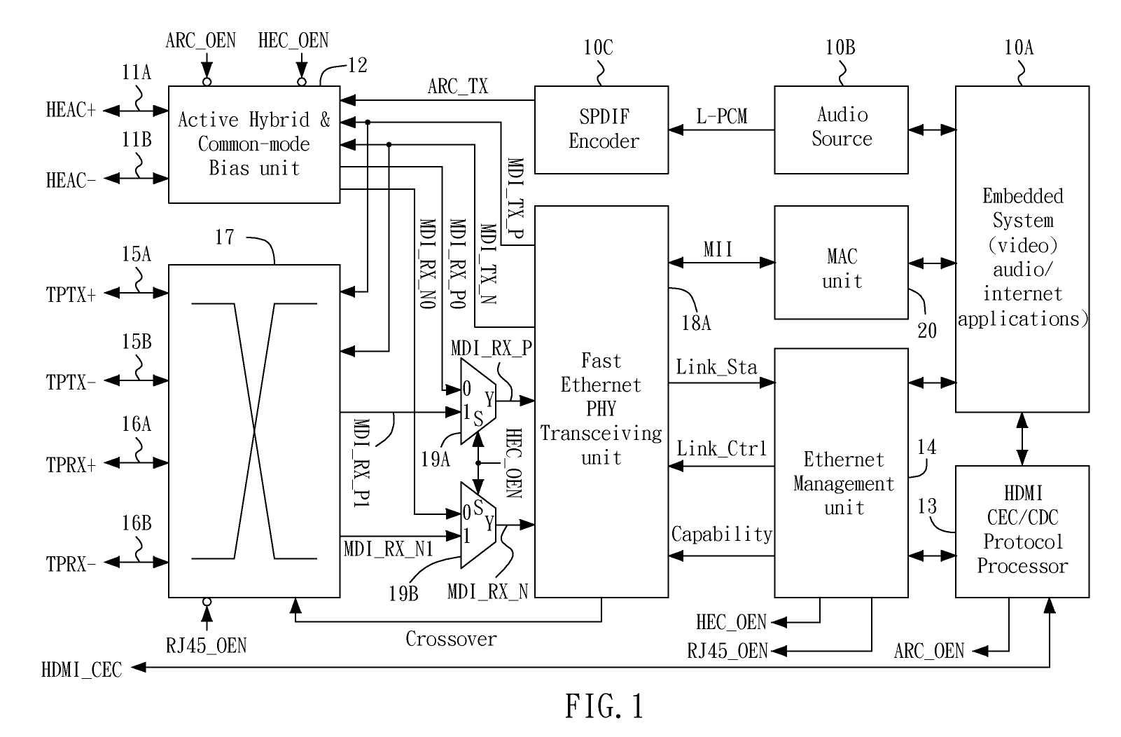

FIG. 1 shows a block diagram of a transceiver having an HDMI Ethernet & Audio Return Channel (HEAC) connection and a wired Ethernet connection according to a first embodiment of the present invention. In the specification, the term “wired Ethernet” is referred to the conventional wired Ethernet standard such as 10BASE or 100BASE. In the embodiment, the HEAC connection adopts HDMI version 1.4 (or later version) that provides 100BASE (or Fast Ethernet) standard at the nominal rate of 100 Mbit/sec, and the wired Ethernet connection adopts Fast Ethernet that provides both the 100BASE (100 Mbit/sec) and 10BASE (10 Mbit/sec) standards. It is appreciated by those skilled in the pertinent art that other (earlier or later) standards may be adopted by the connections instead. The specification of HDMI version 1.4 is hereby incorporated by reference.

In the embodiment, the transceiver has one pair of bi-directional HDMI input/output (I/O) nodes (or pads) 11A and 11B for transferring a pair of differential HEAC signals HEAC+ and HEAC−. An active hybrid & common-mode bias (AHCB) unit 12 is utilized to facilitate the transmission of (a pair of) differential transmission signals MDI_TX_P and MDI_TX_N, the reception of (a pair of) first differential reception signals MDI_RX_P0 and MDI_RX_N0 and the transmission of a (common-mode) audio signal ARC_TX.

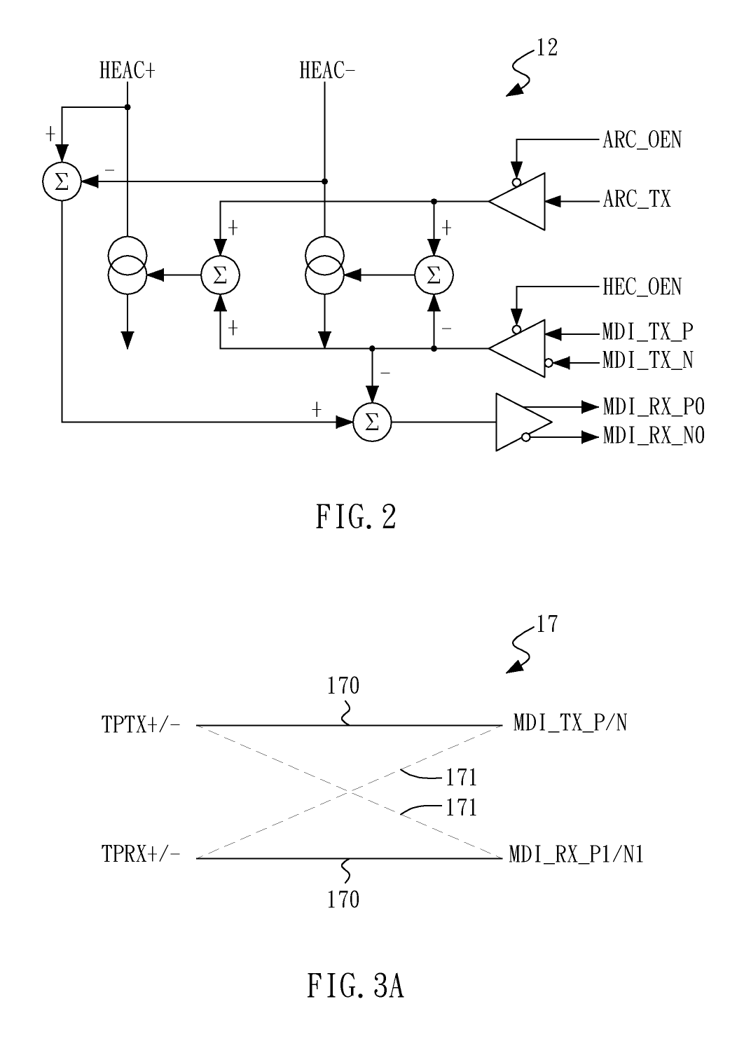

Specifically speaking, the active hybrid portion of the AHCB unit 12 is responsible for the transmission of the differential transmission signals MDI_TX_P and MDI_TX_N and the reception of the first differential reception signals MDI_RX_P0 and MDI_RX_N0; the common-mode bias portion of the AHCB unit 12 is responsible for the transmission of the audio signal ARC_TX, which may, for example, be originated from an embedded system 10A, sourced by an audio source 10B and encoded by SPDIF encoder 10C. The common-mode bias portion may be enabled by an Audio-Return-Channel (ARC) enable signal ARC OEN, which is generated by an HDMI CEC/CDC (Consumer Electronics Control/Capability Discovery Control) protocol processor 13, which determines the ARC capability of a connected device according to a (bi-directional) CEC signal HDMI_CEC. The active hybrid portion may be enabled by an HDMI-Ethernet-Channel (HEC) enable signal HEC_OEN, which is generated by an Ethernet management unit 14, which determines the HEC capability of a connected device. FIG. 2 shows a detailed circuit of an exemplary, but not restricted, implementation of the active hybrid & common-mode bias unit 12.

In the embodiment, the transceiver also has two pairs of bi-directional (wired) Ethernet I/O nodes: the pair of first Ethernet I/O nodes 15A/15B for transferring a pair of first differential Ethernet signals TPTX+/TPTX−, and the pair of second Ethernet I/O nodes 16A/16B for transferring a pair of second differential Ethernet signals TPRX+/TPRX−. An Ethernet line gate 17 is utilized to facilitate the pairing connection between the first differential Ethernet signals TPTX+/TPTX−, the second differential Ethernet signals TPRX+/TPRX−, and the differential transmission signals MDI_TX_P/MDI_TX_N, (a pair of) second differential reception signals MDI_RX_P1 and MDI_RX_N1. In other words, the first differential Ethernet signals TPTX+/TPTX− at the first side may be controllably connected to one of the differential transmission signals MDI_TX_P/MDI_TX_N and the second differential reception signals MDI_RX_P1 and MDI_RX_N1 at the second side, while the second differential Ethernet signals TPRX+/TPRX− at the first side may be controllably connected to the other one at the second side.

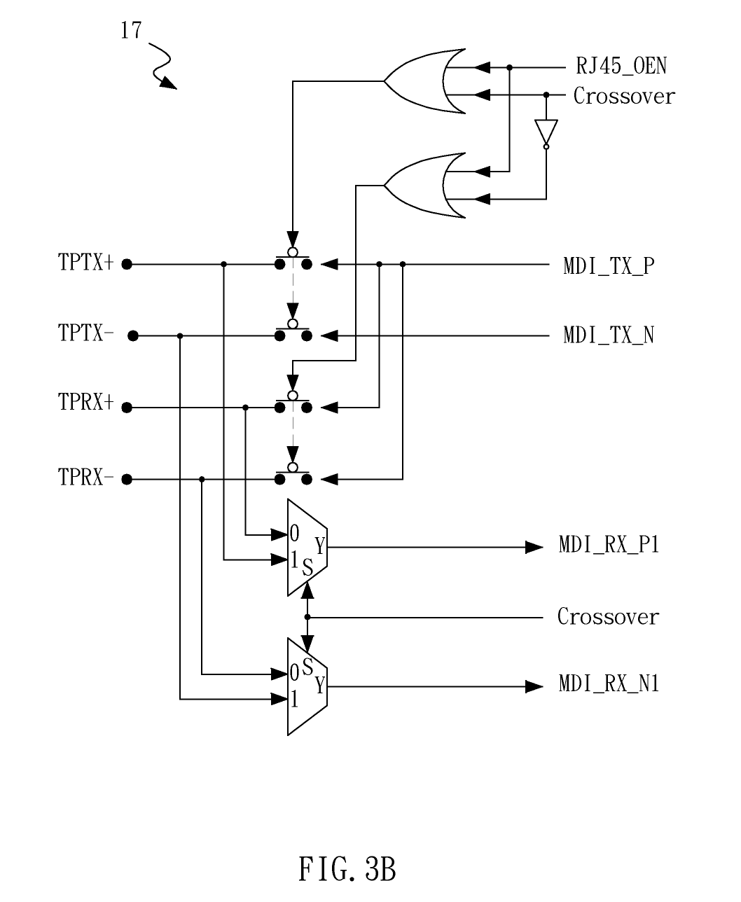

FIG. 3A shows a schematic diagram of the Ethernet line gate 17, according to which two connection types are possible: (1) straight-through connection path 170, that is, the first differential Ethernet signals TPTX+/− are connected with the differential transmission signals MDI_TX_P/N, and the second differential Ethernet signals TPRX+/− are connected with the second differential reception signals MDI_RX_P1/N1; (2) crossover connection path 171, that is, the first differential Ethernet signals TPTX+/− are connected with the second differential reception signals MDI_RX_P1/N1, and the second differential Ethernet signals TPRX+/− are connected with the differential transmission signals MDI_TX_P/N.

FIG. 3B shows a detailed circuit of an exemplary, but not restricted, implementation of the Ethernet line gate 17. The pairing connection of the Ethernet line gate 17 may be controlled by an Ethernet enable signal RJ45_OEN that is generated by the Ethernet management unit 14 and a crossover signal that is generated by a Fast Ethernet physical-layer (PHY) transceiving unit 18A.

In the embodiment, either the first differential reception signals MDI_RX_P0 and MDI_RX_N0 (from the active hybrid & common-mode bias unit 12) or the second differential reception signals MDI_RX_P1 and MDI_RX_N1 (from the Ethernet line gate 17) are selected, for example, through a pair of first multiplexers 19A/19B, according to the HDMI-Ethernet-Channel (HEC) enable signal HEC_OEN, which is generated by the Ethernet management unit 14. The selected differential reception signals MDI_RX_P and MDI_RX_N are then fed to and processed by the Fast Ethernet PHY transceiving unit 18A at a physical layer (or the first layer) of seven-layer OSI (Open Systems Interconnection) model. The differential transmission signals MDI_TX_P and MDI_TX_N from the Fast Ethernet PHY transceiving unit 18A are fed to the active hybrid & common-mode bias unit 12 and the Ethernet line gate 17.

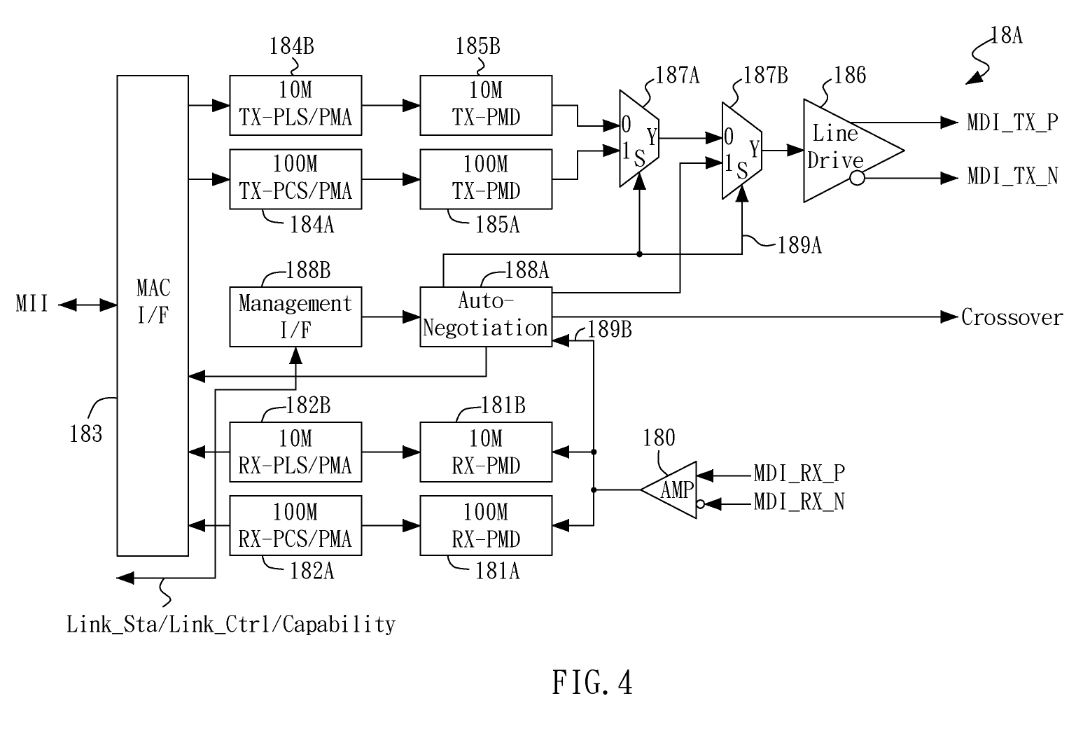

FIG. 4 shows a detailed block diagram of the Fast Ethernet PHY transceiving unit 18A according to the first embodiment. Specifically, after the differential reception signals MDI_RX_P and MDI_RX_N are amplified by an amplifier 180, the differential reception signals MDI_RX_P and MDI_RX_N are processed by a Physical Medium Dependent (PMD) unit 181A and a Physical Coding Sublayer/Physical Medium Attachment (PCS/PMA) unit 182A if the differential reception signals MDI_RX_P and MDI_RX_N are associated with 100BASE standard. Otherwise, the differential reception signals MDI_RX_P and MDI_RX_N are processed by a PMD unit 181B and a Physical Layer Signaling/Physical Medium Attachment (PLS/PMA) unit 182B if the differential reception signals MDI_RX_P and MDI_RX_N are associated with 10BASE standard. The processed differential reception signals MDI_RX_P and MDI_RX_N are finally fed to a Media Access Control (MAC) interface 183 and are prepared to be further processed by a MAC unit 20 at the second layer of seven-layer OSI model. The definitions of the terms “PMD,” “PCS,” “PMA,” “PLS” and “MAC” may be referred to Ethernet specification such as IEEE 802.3 (2000), the disclosure of which is hereby incorporated by reference.

On the other hand, to-be transmitted data provided by the MAC unit 20 are fed to the MAC interface 183, and are processed by a PCS/PMA unit 184A and a PMD unit 185A, and are then driven, for example, by a line drive 186, thereby resulting in the differential transmission signals MDI_TX_P and MDI_TX_N if they are associated with 100BASE standard. Otherwise, the to-be transmitted data are processed by a PLS/PMA unit 184B and a PMD unit 185B, and are then driven by the line drive 186, thereby resulting in the differential transmission signals MDI_TX_P and MDI_TX_N if they are associated with 10BASE standard. The selection between 100BASE and 10BASE is done, for example, by a second multiplexer 187A.

The Fast Ethernet PHY transceiving unit 18A also includes an auto-negotiation unit 188A that is capable of negotiating with a connected device to decide between 100BASE and 10BASE. Specifically, the auto-negotiation unit 188A transmits negotiation signal via a wire 189A, a third multiplexer 187B, and the line drive 186, and receives negotiation signal via the amplifier 180 and another wire 189B. Moreover, according to the negotiation procedure, the auto-negotiation unit 188A generates the crossover signal to the Ethernet line gate 17.

As described above, the Ethernet management unit 14, in the embodiment, may determine the HEC capability of a connected device, generate the Ethernet enable signal RJ45_OEN to control the Ethernet line gate 17, and generate the HDMI-Ethernet-Channel (HEC) enable signal HEC_OEN to control the AHCB unit 12. Furthermore, the Ethernet management unit 14 may inform a management interface 188B of the Fast Ethernet PHY transceiving unit 18A about the capability of a connected device, by a capability signal. The Ethernet management unit 14 may control the management interface 188B, for example, to forcibly select 100BASE, by a link-control signal Link-Ctrl, and the management interface 188B may acknowledge it with a reply signal Link_Sta.

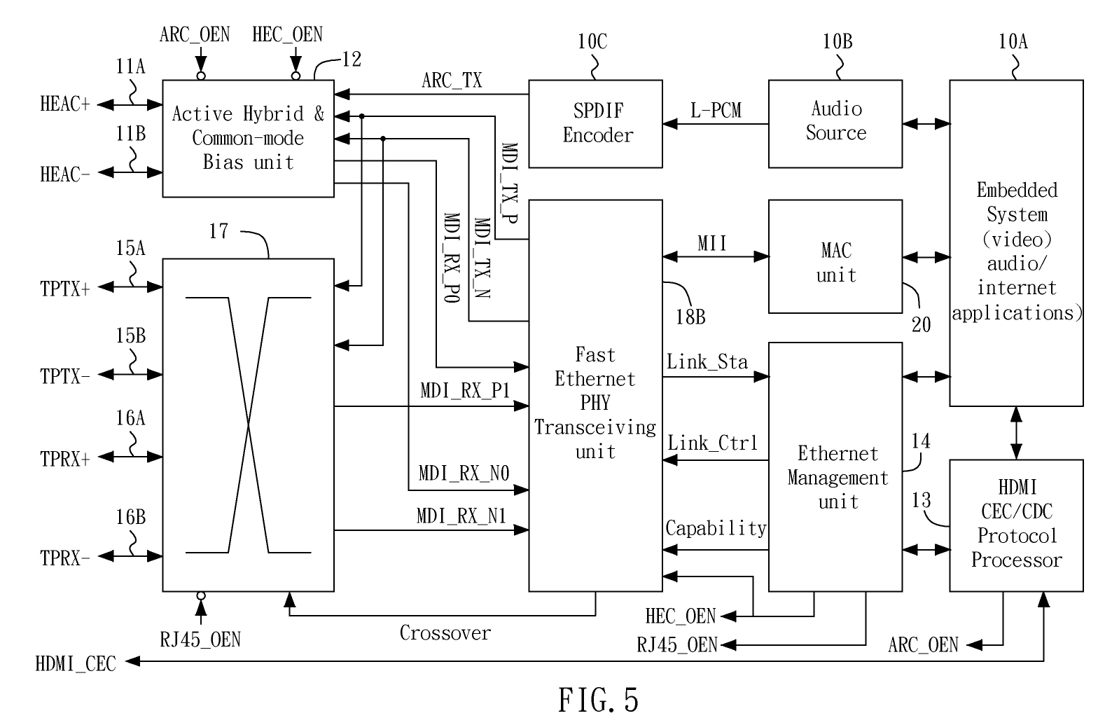

FIG. 5 shows a block diagram of a transceiver having an HDMI Ethernet & Audio Return Channel (HEAC) connection and a wired Ethernet connection according to a second embodiment of the present invention. The second embodiment has architecture similar to that of the first embodiment (FIG. 1) with the exception that the first multiplexers 19A/19B are omitted in the present embodiment. Accordingly, both the first differential reception signals MDI_RX_P0/MDI_RX_N0 (from the active hybrid & common-mode bias unit 12) and the second differential reception signals MDI_RX_P1/MDI_RX_N1 (from the Ethernet line gate 17) are fed to a Fast Ethernet physical-layer (PHY) transceiving unit 18B. Moreover, in the present embodiment, the HDMI-Ethernet-Channel (HEC) enable signal HEC_OEN generated by an Ethernet management unit 14 is also used to control the Fast Ethernet PHY transceiving unit 18B.

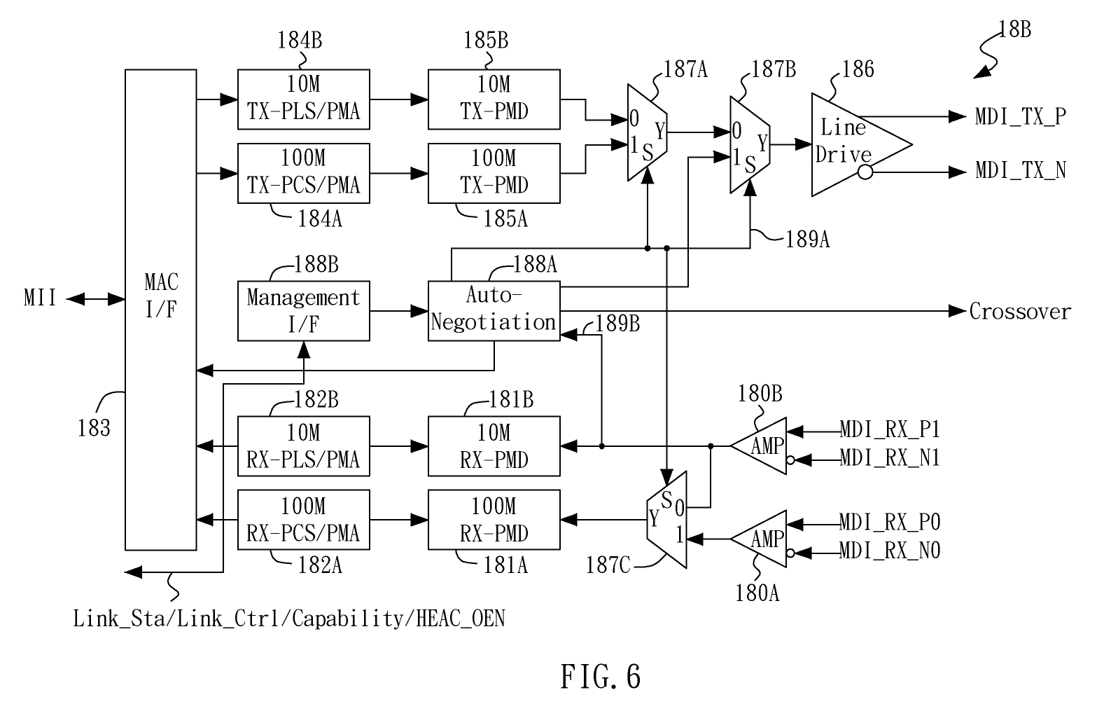

FIG. 6 shows a detailed block diagram of the Fast Ethernet PHY transceiving unit 18B according to the second embodiment. The architecture of the Fast Ethernet PHY transceiving unit 18B in the present embodiment is similar to that of the first embodiment (FIG. 4) with the exception that two amplifiers 180A/180B are required, in the present embodiment, to amplify both the first differential reception signals MDI_RX_P0/MDI_RX_N0 and the second differential reception signals MDI_RX_P1/MDI_RX_N1. Moreover, a fourth multiplexer 187C is used to select one of the outputs of the amplifiers 180A/180B. According to one aspect of the present embodiment, as the signal on the wire 189B is not blocked by any multiplexer, the auto-negotiation unit 188A therefore can still monitor the negotiation signal on the wire 189A even while the Fast Ethernet PHY transceiving unit 18B is directed by the Ethernet management unit 14 to run at 100 Mbit/sec (i.e., 100BASE).

The transceiver according to either embodiment as disclosed above can support both the HDMI Ethernet & Audio Return Channel (HEAC) connection and the conventional wired Ethernet connection in a cost-effective manner. Particularly, a single Fast Ethernet PHY transceiving unit 18A/18B and a single MAC unit 20 are shared between the HEAC connection and the Ethernet connection. Further, the Ethernet management unit 14 accompanied by the HDMI CEC/CDC protocol processor 13 and the auto-negotiation unit 188A can intelligently switch the incoming HDMI and Ethernet signals to obtain an optimized performance. It is noted that each block described above may be implemented by hardware, software, a digital signal processor, an application specific integrated circuit (ASIC) or their combination.

Although specific embodiments have been illustrated and described, it will be appreciated by those skilled in the art that various modifications may be made without departing from the scope of the present invention, which is intended to be limited solely by the appended claims.

What is claimed is:

1. A transceiver having HEAC and Ethernet connections, comprising:
a pair of HDMI input/output (I/O) nodes for transferring a pair of differential HEAC signals;
an active hybrid & common-mode bias (AHCB) unit configured to facilitate transmission of a pair of differential transmission signals, and reception of a pair of first differential reception signals;
a pair of first Ethernet I/O nodes for transferring a pair of first differential Ethernet signals;
a pair of second Ethernet I/O nodes for transferring a pair of second differential Ethernet signals;
an Ethernet line gate configured to controllably connect the first differential Ethernet signals with one pair of the differential transmission signals and a pair of second differential reception signals, and controllably connect the second differential Ethernet signals with the other pair of the differential transmission signals and the second differential reception signals;
a pair of first multiplexers configured to select either the first differential reception signals or the second differential reception signals; and
an Ethernet physical-layer (PHY) transceiving unit configured to receive and process the selected first or second differential reception signals and the differential transmission signals at a physical layer.

2. The transceiver of claim 1, wherein the AHCB unit further facilitates transmission of an audio signal.

3. The transceiver of claim 2, further comprising a protocol processor configured to determine Audio-Return-Channel (ARC) capability of a connected device according to a Consumer Electronics Control (CEC) signal.

4. The transceiver of claim 3, wherein the protocol processor generates an ARC enable signal to control the transmission of the audio signal in the AHCB unit.

5. The transceiver of claim 1, further comprising an Ethernet management unit configured to determine HDMI-Ethernet-Channel (HEC) capability of a connected device.

6. The transceiver of claim 5, wherein the Ethernet management unit generates an HEC enable signal to control the transmission of the differential transmission signals and the reception of the first differential reception signals.

7. The transceiver of claim 5, wherein the Ethernet line gate is controlled by an Ethernet enable signal generated by the Ethernet management unit and a crossover signal generated by the Ethernet PHY transceiving unit.

8. The transceiver of claim 5, wherein the Ethernet management unit informs the Ethernet PHY transceiving unit about capability of a connected device.

9. The transceiver of claim 8, wherein the Ethernet management unit controls to determine a data transfer speed for the Ethernet PHY transceiving unit.

10. The transceiver of claim 1, wherein the Ethernet PHY transceiving unit includes an auto-negotiation unit configured to negotiate with a connected device to decide one of at least two data transfer speeds.

11. A transceiver having HEAC and Ethernet connections, comprising:
a pair of HDMI input/output (I/O) nodes for transferring a pair of differential HEAC signals;
an active hybrid & common-mode bias (AHCB) unit configured to facilitate transmission of a pair of differential transmission signals, and reception of a pair of first differential reception signals;
a pair of first Ethernet I/O nodes for transferring a pair of first differential Ethernet signals;
a pair of second Ethernet I/O nodes for transferring a pair of second differential Ethernet signals;
an Ethernet line gate configured to controllably connect the first differential Ethernet signals with one pair of the differential transmission signals and a pair of second differential reception signals, and controllably connect the second differential Ethernet signals with the other pair of the differential transmission signals and the second differential reception signals; and
an Ethernet physical-layer (PHY) transceiving unit configured to receive the first and second differential reception signals, and then process one of the first and second differential reception signals and the differential transmission signals at a physical layer.

12. The transceiver of claim 11, wherein the AHCB unit further facilitates transmission of an audio signal.

13. The transceiver of claim 12, further comprising a protocol processor configured to determine Audio-Return-Channel (ARC) capability of a connected device according to a Consumer Electronics Control (CEC) signal.

14. The transceiver of claim 13, wherein the protocol processor generates an ARC enable signal to control the transmission of the audio signal in the AHCB unit.

15. The transceiver of claim 11, further comprising an Ethernet management unit configured to determine HDMI-Ethernet-Channel (HEC) capability of a connected device.

16. The transceiver of claim 15, wherein the Ethernet management unit generates an HEC enable signal to control the transmission of the differential transmission signals and the reception of the first differential reception signals.

17. The transceiver of claim 15, wherein the Ethernet line gate is controlled by an Ethernet enable signal generated by the Ethernet management unit and a crossover signal generated by the Ethernet PHY transceiving unit.

18. The transceiver of claim 15, wherein the Ethernet management unit informs the Ethernet PHY transceiving unit about capability of a connected device.

19. The transceiver of claim 18, wherein the Ethernet management unit controls to determine a data transfer speed for the Ethernet PHY transceiving unit.

20. The transceiver of claim 11, wherein the Ethernet PHY transceiving unit includes an auto-negotiation unit configured to negotiate with a connected device to decide one of at least two data transfer speeds.

21. The transceiver of claim 20, wherein the auto-negotiation unit monitors negotiation procedure while the Ethernet PHY transceiving unit is directed by the Ethernet management unit to run at a specific data transfer speed.
